(19) United States
(12) Patent Application Publication
(10) Pub. No.: US 2023/0095843 A1
(43) Pub. Date: Mar. 30, 2023

(54) DRY AQUAFABA BASED EDIBLE PRODUCT AND METHOD OF MAKING SAME

(71) Applicant: FABUMIN LTD., Tel Aviv (IL)

(72) Inventors: Adi LENGEL, Tel Aviv (IL); Adi YEHEZKELI, Tel Aviv (IL)

(73) Assignee: FABUMIN LTD., Tel Aviv (IL)

(21) Appl. No.: 17/909,406

(22) PCT Filed: Mar. 3, 2021
(86) PCT No.: PCT/IL2021/050238

§ 371 Date: Sep. 5, 2022

Related U.S. Application Data
(60) Provisional application No. 62/985,436, filed on Mar. 5, 2020.

(51) Int. Cl. A23L 11/00; A23L 15/00; A23L 5/00; A23L 19/00; A23L 33/185; A23L 33/125; A23L 33/22

(52) U.S. Cl. CPC A23L 11/00; A23L 15/35; A23L 5/51; A23L 19/01; A23L 33/185; A23L 33/125; A23L 33/22; A23V 2002/00

(57) ABSTRACT

A dry aquafaba based powder is disclosed. The dry aquafaba based powder may include, aquafaba and an additive. The additive may be at least one of: a carbohydrate, a legume protein, legumes starch, legume fibers, maltodextrin, inulin, or a combination thereof. In some embodiments, the aquafaba is produced from a legume. The legume may be at least one of: chickpeas, beans, soybeans, peas, lentils, lupins, and a combination thereof.

### CROSS REFERENCE TO RELATED APPLICATIONS

This application claims the benefit of U.S. Provisional Application No. 62/985,436, filed on Mar. 5, 2020, which is incorporated in their entirety herein by reference.

### FIELD OF THE INVENTION

The present invention relates to aquafaba based edible product. More particularly, the present invention relates to dry aquafaba based edible product.

### BACKGROUND OF THE INVENTION

Aquafaba is the viscous water in which legumes such as chickpeas have been cooked. Aquafaba has the ability to mimic functional properties of eggs, such as, forming vegan whip cream. Therefore, aquafaba can be used to make vegan meringues, marshmallows and the like. Aquafaba needs to be kept fresh in order to benefit from its special properties. To produce commercial amounts of aquafaba with long shelf life the aquafaba must be dried.

The current method used for drying aquafaba is the well-known and expensive method of dry freeze.

An additional known drying method is direct spray drying. When used for drying aquafaba viscus water it results in a highly hygroscopic powder which is, therefore, unsuitable for long shelf-life products.

Drying aquafaba using cheap low-cost commercial methods such as drum-drying, spry drying or drying oven, result in a thick “gum-like” texture that cannot be grinded into powder.

Accordingly, there is a need for a cheap, simple method of drying aquafaba that may provide a low-cost product with a long shelf life.

### SUMMARY OF THE INVENTION

Some aspects of the invention may be directed to dry aquafaba based powder comprising aquafaba and an additive. In some embodiments, the additive is at least one of: a carbohydrate, a legume protein, legumes starch, legume fibers, maltodextrin, inulin, or a combination thereof. In some embodiments, the aquafaba is produced from a legume. In some embodiments, the legume is at least one of: chickpeas, beans, soybeans, peas, lentils, lupins, and a combination thereof. In some embodiments, the legume protein is at least one of: chickpea protein, bean protein, soybean protein, mung bean protein, pea protein, faba bean protein, quinoa protein, pulses & legumes protein and a combination thereof.

In some embodiments, the carbohydrate is at least one of: an oligosaccharide, a polysaccharide, or a combination thereof. In some embodiments, the oligosaccharide is maltodextrin. In some embodiments, the polysaccharide is a starch or a fiber. In some embodiments, the fiber is at least one of: inulin, dextrin, chickpea fiber, soybean fiber, pea fiber, corn fiber, cellulose, lignin, psyllium, and a combination thereof. In some embodiments, the aquafaba is produced from chickpeas with chickpea protein additive and an additional additive.

In some embodiments, the aquafaba based product comprises between 10-80 wt. % protein. In some embodiments, the amount of additive is about 0.1-40 wt. %.

Some aspects of the invention may be directed to a vegan egg foam comprising: the dry aquafaba based powder according to any embodiments of the invention; and an aqueous solution. In some embodiments, the vegan egg powder concentration is about 1-15% (w/w).

Some additional aspects of the invention may be directed to a vegan egg powder comprising aquafaba produced from chickpeas and an additive comprising chickpea protein. In some embodiments, the vegan egg powder may be mixed with aqueous solution to form a vegan egg foam.

Some aspects of the invention may be directed to a method of preparing a dry aquafaba based powder. In some embodiments, the method includes: providing an aquafaba solution; adding an additive and stirring to produce a combined solution; and drying the combined solution to produce the dry aquafaba based powder, wherein the additive is selected from: a carbohydrate, a legume protein, a legume fiber, or a combination thereof. In some embodiments, the method may include concentrating the aquafaba solution.

Some additional aspects of the invention may be directed to a method of preparing a vegan egg powder. In some embodiments, the method includes: providing a chickpea aquafaba solution; adding an additive, comprising chickpea protein, and stirring to produce a combined solution; and drying the combined solution to produce the vegan egg powder. In some embodiments, the method may include concentrating the aquafaba solution.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 shows a flowchart of a method of making dry aquafaba based edible product, according to some embodiments of the invention; and

FIG. 2 shows image of a foam made by foaming a dry aquafaba based edible product, according to some embodiments of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The current invention relates to a dry aquafaba based edible powder (e.g., a vegan egg powder) comprising aquafaba and an additive. The invention further relates to a method of preparing the dry aquafaba based edible powder comprising: providing an aquafaba solution, adding an additive, and stirring to produce a combined solution, followed by drying the combined solution to produce the vegan egg powder.

In one embodiment the invention relates to a vegan egg powder comprising aquafaba produced from chickpeas and an additive comprising chickpea protein. In one embodiment the invention relates to a method of preparing a vegan egg powder comprising: providing a chickpea aquafaba solution, adding an additive, comprising chickpea protein, and stirring to produce a combined solution, followed by drying the combined solution to produce the vegan egg powder. Such a product may include only materials and compounds originating from chickpeas.

Some aspects of the invention may be related to a dry aquafaba based edible product that may have a long shelf life at room temperature (e.g., more than 2 months) and when mixed with an aqueous liquid forms a viscous liquid that can be whipped for many culinary uses. A dry aquafaba based edible product according to some embodiments of the invention may be produced by mixing liquid aquafaba and 0.1-40 (w/w) of an additive that may be a protein or a polysaccharide from vegetal origin. In some embodiments, the liquid mixture may be then dried using any known method.

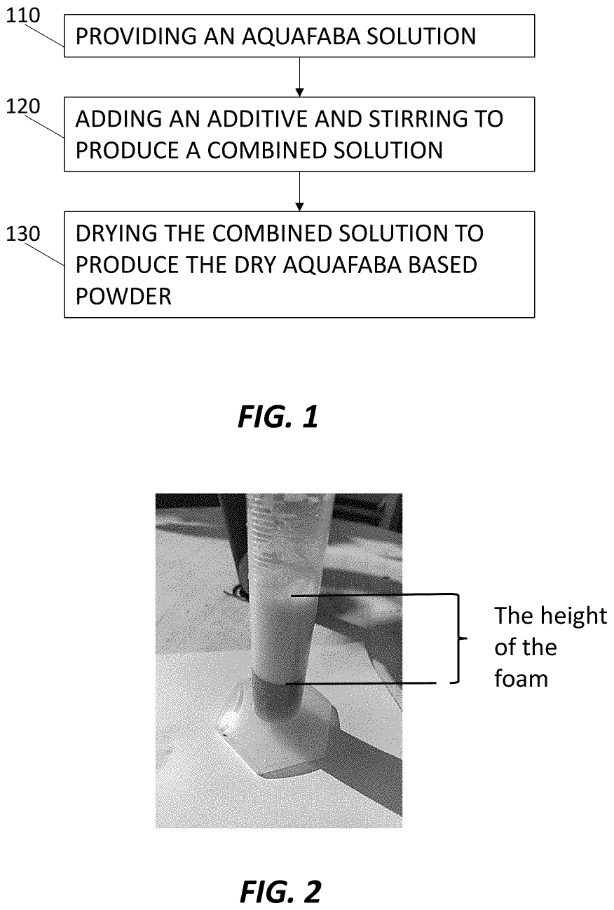

Reference is now made to FIG. 1 which is a flowchart of a method of making dry aquafaba based edible product according to some embodiments of the invention. In step 110 an aquafaba liquid may be provided.

In some embodiments, legumes, such as, chickpeas, beans, soybeans, lentils and the like, may be immersed in water for a sufficient amount of time, followed by extracting (e.g., filtering) the legumes from the water. In some embodiments, more than one type of legume may be immersed in the water, for example, chickpeas and beans. In some embodiments, immersing the legumes may be followed by cooking them in water until softening and then extracting the legumes from the produced aquafaba. The aquafaba may further be reduced (e.g., boiled) to form a concentrated (e.g., viscose) aquafaba liquid. In some embodiments, the legumes may be filtered from the water after the reduction. In a nonlimiting example, 1 kg of chickpeas was immersed in water for 12 hours. The chickpeas were then cooked in 2.5 liters of water until softening and then filtered out from the water.

The 2.5 liters of filtered water (e.g., chickpeas aquafaba) were reduced to 0.5 liter of concentrated chickpeas aquafaba.

In some embodiments the legumes may be: adzuki beans, black beans, soybeans, anasazi beans, fava beans, chickpeas (garbanzo beans), kidney beans, lima beans, mung beans, navy beans, green peas, snow peas, snap peas, split peas and black-eyed peas, lentils (yellow, orange/red, green, brown or black), lupins or a combination thereof. In some embodiments the legumes are chickpeas. In some embodiments the legumes are a combination of chickpeas and soybeans. In some embodiments, the legumes are a combination of chickpeas and peas. In some embodiments the legumes are peas. In some embodiments the legumes are soybeans.

In some embodiments the aquafaba comprises 1-20% protein.

In step 120, an additive may be added to the aquafaba liquid. In some embodiments, the additive may be from a vegetal origin. In some embodiments, the additive may be a protein, for example, a vegetal protein such as, a chickpeas protein, lentils protein and the like. In some embodiments, the additive may be a polysaccharide, for example, maltodextrin, modified potato starch and the like. In some embodiments, an amount of 1-80 gr of additive may be added to every liter of aquafaba liquid. In some embodiments, an amount of 0.1-40 wt. % additive may be added to the aquafaba solution. In a nonlimiting example, 25 grams of chickpeas protein was added to 0.5 liters of concentrated chickpeas aquafaba.

In step 130, the aquafaba liquid and the additive may be mixed, using any known method or devise. For example, any commercial mixer used in the food industry or any utensil used for home cooking may be used to mix the aquafaba liquid and the additive.

The additive may be added together with the legumes and immersed in water. In some embodiments the additive may be added after the legumes are extracted but before the aquafaba is reduced. In some embodiments the additive may be added after the aquafaba is reduced.

In some embodiments the additive is a vegetal protein. In some embodiments the vegetal protein may be chickpeas protein, lentils protein, pea protein, soybean protein or a combination thereof. In some embodiments the additive is chickpea protein. In some embodiments the additive is pea protein. In some embodiments the additive is soybean protein. In some embodiments the protein is a protein concentrate. In some embodiments the protein concentrate may be from chickpeas, soybeans, peas or a combination thereof. In some embodiments the chickpea concentrate comprises about 60-95% protein. In some embodiments the chickpea concentrate comprises about 90% protein. In some embodiments the chickpea concentrate comprises about 80% protein. In some embodiments the chickpea concentrate comprises about 70% protein. In some embodiments the chickpea concentrate comprises about 60% protein. In some embodiments the soybean concentrate comprises about 60-95% protein. In some embodiments the soybean concentrate comprises about 90% protein. In some embodiments the soybean concentrate comprises about 80% protein. In some embodiments the soybean concentrate comprises about 70% protein. In some embodiments the soybean concentrate comprises about 60% protein. In some embodiments the chickpea concentrate comprises about 60% protein. In some embodiments the pea concentrate comprises about 60-95% protein. In some embodiments the pea isolate comprises about 90% protein. In some embodiments the pea concentrate comprises about 80% protein. In some embodiments the pea concentrate comprises about 70% protein. In some embodiments the pea concentrate comprises about 60% protein. In some embodiments, the aquafaba based product may include between 10-80 wt. % protein.

In some embodiments the additive is a carbohydrate. In some embodiments the carbohydrate is an oligosaccharide. In some embodiments the oligosaccharide is maltodextrin. In some embodiments the carbohydrate is a polysaccharide. In some embodiments the polysaccharide is a starch. In some embodiments the polysaccharide is a fiber. In some embodiments the fiber is a soluble fiber. In some embodiments the fiber may be: inuline, dextrin, Isomalt chickpea fiber, soybean fiber, pea fiber, corn fiber, cellulose, lignin, psyllium and the like or a combination thereof. In some embodiments the fiber is an insoluble fiber. In some embodiments the fiber may be Swelite, hi fiber and the like or a combination thereof.

In step 140, the mixture may be dried using any known method. The mixture may be dried to form a dry aquafaba based powder.

The inventors surprisingly found that the addition of the additive enables successfully using spray drying to prepare a stable dry aquafaba based powder with a long shelf life, compared to spry draying concentrated aquafaba liquid with no additive.

In some embodiments the mixture may be dried in hot air, in an oven, and the like at a temperature range of about 30-200° C. In some embodiments the mixture may be spray dried. In some embodiments the mixture may be freeze dried. In some embodiments the mixture may be dried using a drum dryer. In some embodiments the mixture may be dried using a pulse combustion dryer. In some embodiments the mixture may be dried using a heat oven.

In some embodiments, the dry aquafaba based product may have a form selected from: fine powder, granular powder, tablets, capsules and the like. In some embodiments, the dry aquafaba based product may be in the form of powder.

In some embodiments the powder particle size is between about 0.05-1.5 mm.

In some embodiments the color of the powder ranges from pearl white to brawn. In some embodiments the color of the powder is pearl white. In some embodiments the color of the powder is yellowish. In some embodiments the color of the powder is yellowish brawn. In some embodiments the color of the powder is yellowish white. In some embodiments, the powder has the color of an egg white.

In some embodiments the vegan egg powder is dissolved in an aqueous liquid to form a vegan egg solution. In some embodiments the aqueous liquid is water. In some embodiments the liquid is a milk substitute such as soy milk, almond milk, oatmeal milk and the like. In some embodiments the solution is a juice such as orang juice, apple juice and the like.

In some embodiments, vegan egg solution is whipped up to create a whipped cream/a foam. The vegan egg solution may be whipped with a hand whip, electric whip, electric mixer or hand mixer or with any other utensil or way. The whipped cream may be used for baking or any other food in which an egg based whipped cream would be used for. The whipped cream may also be used in beverages such as coffee, hot chocolate, cocktails and the like.

In some embodiments the formed foam (including non-whipped solution) is double the volume of the original solution.

In some embodiments the vegan egg solution has high adhesive properties and may be used to substitute egg(s) in any food item in which eggs are used for their adhesiveness properties such as cakes, cookies, pancakes, patties, vegan meat analogs (such as burgers, hot-dogs, meatballs and the like) and the like.

### EXAMPLES

### Example 1— Preparing the Aquafaba

1 kg of chickpeas was immersed in water for 12 hours. The chickpeas were cooked in 2.5 liters of water until softening and then filtered out from the water. The filtered water (e.g., chickpeas aquafaba) were reduced to 0.5 liter of concentrated chickpeas aquafaba.

### Example 2— Preparing the Vegan Egg Powder

### Materials:

Chickpea aquafaba (prepared according to example 1)
Additives: Inuline, dextrin, chickpea isolated protein, chickpea concentrate, maltodextrin, isomalt, Insoluble inner pea fiber and Insoluble hemp fiber.

| Trial | | |
|---|---|---|
| Number | Additive | Type |
| 1 | Inuline | soluble fiber |
| 2 | Dextrin | soluble fiber |
| 3 | chickpea concentrate with 90% protein | protein |
| 4 | chickpea concentrate with 70% protein | protein |
| 5 | Maltodextrin | starch |
| 6 | Isomalt | soluble fiber |
| 7 | Insoluble inner pea fiber | insoluble pea fiber |
| 8 | Insoluble hemp fiber | Insoluble hemp fiber |
| S | Soy isolate protein 90% | protein |
| P | Pea concentrate protein 70% | protein |

### Spray Drying Parameters:

Buchi Lab Spray Dryer B290
nozzle height 0.15 m″m
Air flow temp— 185° C.
Outflow temp— 116° C.
Pump @ 15%
Turbine— 91%
PULSE=2

### Procedure:

1 liter of aquafaba was mixed at room temperature with 20 g of an additive. The solution was then dried by spray drying to create a powder. The following characteristics of the power, detailed in table 1 below, were checked and/or measured and the results are detailed in table 2 below.

Table 1:

TABLE 1

| Properties | Test settings |
|---|---|
| NON-Sticking | significant amount of matter sticking to vessel after spray |
| to SD vessel | drying. |
| SD parameter | The change of SD parameters needed for proper drying |
| steady | the matter. |
| Size | Particle size in millimeter. |
| Color | The color of the powder was evaluated by basic visual |
| | means. |
| Foaming and | For each powder (aquafaba + additive): |
| foaming after | 1) A solution of powder in hot water at a concentration |
| 12 hours rest | of 12.5% was prepared. |
| | 2) The solution was cooled to room temperature and the |
| | color was examined. |
| | 3) 20 cc of the solution was poured into a vase and |
| | whipped in it for 3 minutes by a tiny electric whisk. |
| | 4) the height of the liquid column + foam was measured. |
| | 5) After 30 minutes the height of the liquid formed under |
| | the foam is measured (i.e., the height of the liquid |
| | formed during the damping of the foam). |
| Brix | Brix was tested using an “atago” pocket refractometer. |
| Solubility | A water diluted composition of 0.2 C. was shaken by |
| | hand for 30 seconds and reviewed 4 hours later. |
| Sedimentation | Sedimentation no stir was tested by adding 2 g |
| (no stir) | composition to 80 ml water and reviewing every 10 min, |
| | 3 times (at times 0 min, 10 min, 20 min and 30 min). |
| Emulsification | Emulsification properties was tested by adding 2 g |
| properties | composition to 80 ml water and 20 ml sunflower oil, |
| | followed by a 30 second shake by hand and reviewed |
| | after one day. |
| Adhesiveness | 1 g composition was diluted with 2.5 g water to create a |
| | thick liquid that was tested by ′TA. XT. plus texture |
| | analyzer' in an adhesiveness test (P/36R probe). |

Table 2A: Test results:

TABLE 2A
Test results:

| Trial | Non Sticking | SD parameters | | | | |
|---|---|---|---|---|---|---|
| Number | to SD vessel | steady | Size | | Color | pH |
| 1 | V | V | 1 | mm | Light | 6.3 |
| | | | | | yellowish | |
| 2 | V | V | 0.4 | mm | Yellowish | 6.3 |
| 3 | V | V | 0.8 | mm | Yellowish | 6.2 |
| | | | | | brawn | |
| 4 | STICKS | V | 1.34 | mm | Yellowish | 6.3 |
| | | | | | brawn | |
| 5 | V | V | 0.14 | mm | Light | 5.5 |
| | | | | | yellowish | |
| | | | | | brawn | |
| 6 | V | V | 0.5 | mm | Light | 5.4 |
| | | | | | yellowish | |
| 7 | V | V | 0.25 | mm | Light | 6.2 |
| | | | | | yellowish | |
| 8 | V | V | 0.17 | mm | Light | 5.5 |
| | | | | | yellowish | |

| | |
|---|---|
| S | N/A |
| P | N/A |

Table 2B: Test results:

TABLE 2B
Test results:

Foaming
(low 1-10 high)

| Trial Number | foaming | After 12 h |
|---|---|---|
| 1 | 36 | 17 |
| 2 | 40 | 17 |
| 3 | 35 | 20 |
| 4 | 40 | 16 |
| 5 | 40 | 15 |
| 6 | 40 | 16 |
| 7 | 40 | 15 |
| 8 | 40 | 17 |

Table 2C: Test results:

TABLE 2C
Test results:

| Trial | Solubility | Brix | Adhesiveness |
|---|---|---|---|
| Number | (high 1-10 low) | (°Bx) | (low 1-10 high) |
| 1 | 3 | 1.4 | 4 |
| 2 | 3 | 0.7 | 6 |
| 3 | 2 | 1.6 | 3 |
| 4 | 1 | 1 | 9 |
| 5 | 3 | 1.6 | 10 |
| 6 | 8 | 0.5 | 6 |
| 7 | 4 | 0 | 6 |
| 8 | 10 | 0.1 | 1 |

| | | |
|---|---|---|
| S | 5 | N/A |
| P | 4 | N/A |

### Example 3— Foam

Vegan egg powders were prepared according to example 2. Each was prepared with a different additive according to the table 3 below.

Each vegan egg powder was mixed, separately, with warm water to create a solution with a powder weight concentration of 12.5% (w/w).

The solution was cooled to room temperature and the color of the solution was observed. The observations are detailed below in table 3.

20 ml of the solution were placed in a graduated cylinder and were beat/whipped with a small electric beater for 3 minutes to create a foam. The diameter of the graduated cylinder was 26 mm and the total height 150 mm.

After three minutes the height (in ml) of the solution and foam, in the graduated cylinder, were measured.

After 30 minutes the foam decrease was measured by measuring the height (in ml) of the solution in the graduated cylinder.

Table 3:

TABLE 3

| | | Foam | Soloution |
|---|---|---|---|
| | | hight after | hight after |
| | Soloution | 3 minutes | 30 minutes |
| Additive | color | (ml) | (ml) |
| Inulin | Light yellowish | 36 | 17 |
| Dextrin | Yellowish | 40 | 17 |
| Chick-P | Yellowish brawn | 35 | 20 |
| concentrate 70% | | | |
| Chick-P | Yellowish brawn | 40 | 16 |
| concentrate 90% | | | |
| Maltodextrin | Light yellowish | 40 | 15 |
| | brawn | | |
| Isomalt | Light yellowish | 40 | 16 |
| Insoluble inner | Light yellowish | 40 | 15 |
| pea fiber | | | |
| Insoluble hemp | Light yellowish | 40 | 17 |
| fiber | | | |

Reference is now made to FIG. 2 which is an image of a whipped chickpea solution made with a chickpea additive according to the parameters of Example 3.

As can clearly shown in FIG. 2 and that data given gathered in Examples 1-3, an dry aquafaba based product may be used as a vegan egg substitute, which is addition to being whipped may also be used as thickener and glue. Such a product may be produced by drying a solution using simple commercial methods.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A dry aquafaba based powder comprising aquafaba and an additive, wherein the additive is at least one of: a carbohydrate, a legume protein, legumes starch, legume fibers, Maltodextrin, inulin, or a combination thereof.

2. The dry aquafaba based powder of claim 1, wherein the aquafaba is produced from a legume.

3. The dry aquafaba based powder of claim 2, wherein the legume is at least one of: chickpeas, beans, soybeans, peas, lentils, lupins, and a combination thereof.

4. The dry aquafaba based powder according to claim 1, wherein the legume protein is at least one of: chickpea protein, bean protein, soybean protein, mung bean protein, pea protein, faba bean protein, quinoa protein, pulses & legumes protein and a combination thereof.

5. The dry aquafaba based powder according to claim 1, wherein the carbohydrate is at least one of: an oligosaccharide, a polysaccharide, or a combination thereof.

6. The dry aquafaba based powder of claim 5, wherein the oligosaccharide is maltodextrin.

7. The dry aquafaba based powder of claim 5, wherein the polysaccharide is a starch or a fiber.

8. The dry aquafaba based powder of claim 5, wherein the fiber is at least one of: inulin, dextrin, chickpea fiber, soybean fiber, pea fiber, corn fiber, cellulose, lignin, psyllium, and a combination thereof.

9. The dry aquafaba based powder according to claim 1, comprising aquafaba produced from chickpeas, chickpea protein and an additional additive.

10. The dry aquafaba based powder according to claim 1, wherein the aquafaba based product comprises between 10-80 wt. % protein.

11. The dry aquafaba based powder according to claim 1, wherein the amount of additive is about 0.1-40 wt. %.

12. (canceled)

13. A vegan egg powder comprising aquafaba produced from chickpeas and an additive comprising chickpea protein.

14. (canceled)

15. (canceled)

16. A method of preparing a dry aquafaba based powder comprising:
providing an aquafaba solution;
adding an additive and stirring to produce a combined solution; and
drying the combined solution to produce the dry aquafaba based powder, wherein the additive is selected from: a carbohydrate, a legume protein, a legume fiber, or a combination thereof.

17. The method of claim 16, further comprising concentrating the aquafaba solution.

18-19. (canceled)
